(19) United States
(12) Patent Application Publication
(10) Pub. No.: US 2017/0093685 A1
(43) Pub. Date: Mar. 30, 2017

(54) GENERATING SERVICE-OPTIMIZED PATHS BASED ON ENHANCED EIGRP TELEMETRY

(71) Applicant: Cisco Technology, Inc., San Jose, CA (US)

(72) Inventors: ALVARO ENRIQUE RETANA, Raleigh, NC (US); YI YANG, Cary, NC (US); DONNIE VAN SAVAGE, Raleigh, NC (US)

(21) Appl. No.: 14/869,217

(22) Filed: Sep. 29, 2015

(51) Int. Cl. H04L 12/751

(52) U.S. Cl. CPC H04L 45/02

(57) ABSTRACT

In one embodiment, a method comprises an Enhanced Interior Gateway Routing Protocol (EIGRP) route server device receiving an EIGRP update message that includes telemetry information associated with an EIGRP router, the telemetry information including service-based attributes associated with the telemetry information; and the EIGRP route server device generating one or more service-optimized paths for reaching a destination network device based on the telemetry information, enabling any EIGRP router to reach the destination network device according to an identified service type based on the one or more service-optimized paths.

### TECHNICAL FIELD

The present disclosure generally relates to generation of service-optimized paths based on Enhanced Interior Gateway Routing Protocol (EIGRP) telemetry.

### BACKGROUND

This section describes approaches that could be employed, but are not necessarily approaches that have been previously conceived or employed. Hence, unless explicitly specified otherwise, any approaches described in this section are not prior art to the claims in this application, and any approaches described in this section are not admitted to be prior art by inclusion in this section.

The Enhanced Interior Gateway Routing Protocol (EIGRP) is a distance vector-based routing protocol that enables EIGRP-enabled routers to initially exchange routing information, enabling each EIGRP router to identify its neighboring topology (i.e., its next-hop neighbors). Once an EIGRP router has established its corresponding topology table (identified destination addresses reachable via next-hop neighbors) and routing table (e.g., based on the Diffusing Update Algorithm (DUAL)), an EIGRP router only needs to send an EIGRP-based update message only if a link transition occurs that affects the network topology. Unlike link-state routing protocols (e.g., Intermediate System to Intermediate System (IS-IS) or Open Shortest Path First (OSPF)), an EIGRP router is not aware of the network topology beyond its adjacent neighbor.

Segment Routing (SR) enables a network node to select an explicit path for a traffic class. Segment routing relies on a set of “segments” that are advertised by link-state routing protocols such as IS-IS or OSPF. A nodal segment represents a multi-hop path to a node, and an adjacency segment represents a single-hop path to an adjacent node. Segments act as topological sub-paths that can be combined together to form an explicit path to a destination.

### BRIEF DESCRIPTION OF THE DRAWINGS

Reference is made to the attached drawings, wherein elements having the same reference numeral designations represent like elements throughout and wherein:

FIG. 1 illustrates an example system having an apparatus generating service-optimized paths for reaching a destination based on telemetry information in a received EIGRP update message, according to an example embodiment.

FIG. 2 illustrates an example EIGRP update message containing telemetry information associated with one or more EIGRP routers, according to an example embodiment.

FIG. 3 illustrates an example segment routing database (SRDB) maintained by the EIGRP route server of FIG. 1 and containing service-optimized paths, according to an example embodiment.

FIG. 4 illustrates an example implementation of any of the devices of FIG. 1.

FIGS. 5A and 5B illustrate an example method of the devices of FIG. 1 in the outputting of an EIGRP update message containing telemetry information, and generating one or more service-optimized paths based on the telemetry information, according to an example embodiment.

### DESCRIPTION OF EXAMPLE EMBODIMENTS

### Overview

In one embodiment, a method comprises an Enhanced Interior Gateway Routing Protocol (EIGRP) route server device receiving an EIGRP update message that includes telemetry information associated with an EIGRP router, the telemetry information including service-based attributes associated with the telemetry information; and the EIGRP route server device generating one or more service-optimized paths for reaching a destination network device based on the telemetry information, enabling any EIGRP router to reach the destination network device according to an identified service type based on the one or more service-optimized paths.

In another embodiment, an apparatus comprises a device interface circuit and a processor circuit. The device interface circuit is configured for receiving an EIGRP update message that includes telemetry information associated with an EIGRP router, the telemetry information including service-based attributes associated with the telemetry information. The processor circuit is configured for generating one or more service-optimized paths for reaching a destination network device based on the telemetry information, enabling any EIGRP router to reach the destination network device according to an identified service type based on the one or more service-optimized paths.

In another embodiment, one or more non-transitory tangible media are encoded with logic for execution by a machine and when executed by the machine operable for: receiving an EIGRP update message that includes telemetry information associated with an EIGRP router, the telemetry information including service-based attributes associated with the telemetry information; and generating one or more service-optimized paths for reaching a destination network device based on the telemetry information, enabling any EIGRP router to reach the destination network device according to an identified service type based on the one or more service-optimized paths.

In another embodiment, an apparatus comprises a processor circuit and a device interface circuit. The processor circuit is configured for generating an Enhanced Interior Gateway Routing Protocol (EIGRP) update message that includes telemetry information generated by the processor circuit based on detected attributes associated with the apparatus. The device interface circuit is configured for outputting the EIGRP update message to an adjacent router device, for generation of a service-optimized path for reaching a destination network device.

### DETAILED DESCRIPTION

Particular embodiments enable generation of service-optimized paths in a data network based on EIGRP telemetry information associated with an EIGRP router, where the telemetry information includes service-based attributes that enable an EIGRP route server device to generate the service-optimized paths for reaching a destination network device according to one or more identified service types. An EIGRP router can detect the telemetry information, including for example service-based attributes allocated to the EIGRP router, topology information associated with the EIGRP router, etc., and add the telemetry information to an EIGRP update message output by the EIGRP router.

An EIGRP route server device, in response to receiving the EIGRP update message containing the telemetry information, can generate a service-based topology map of identified EIGRP routers that includes the topology information of the identified EIGRP routers relative to the associated service-based attributes; the EIGRP route server device also can generate one or more of the service-optimized paths for one or more identified service types, enabling any EIGRP router to reach a destination network device according to an identified service type based on a service-optimized path.

Hence, the example embodiments enable the deployment of service-optimized paths in a network using EIGRP router devices that can advertise, to an EIGRP route server, selected telemetry information including service-based attributes, topology information (e.g., Segment-Routing local information such as topology and Segment Identifiers (IDs) specific to an EIGRP router device), etc. The advertisement by the EIGRP router devices using EIGRP update messages containing telemetry information enables an EIGRP based network to become topology-aware and service-class aware. Further collection of telemetry information for EIGRP router devices beyond a summary point in a network can be executed by a PCE or equivalent device.

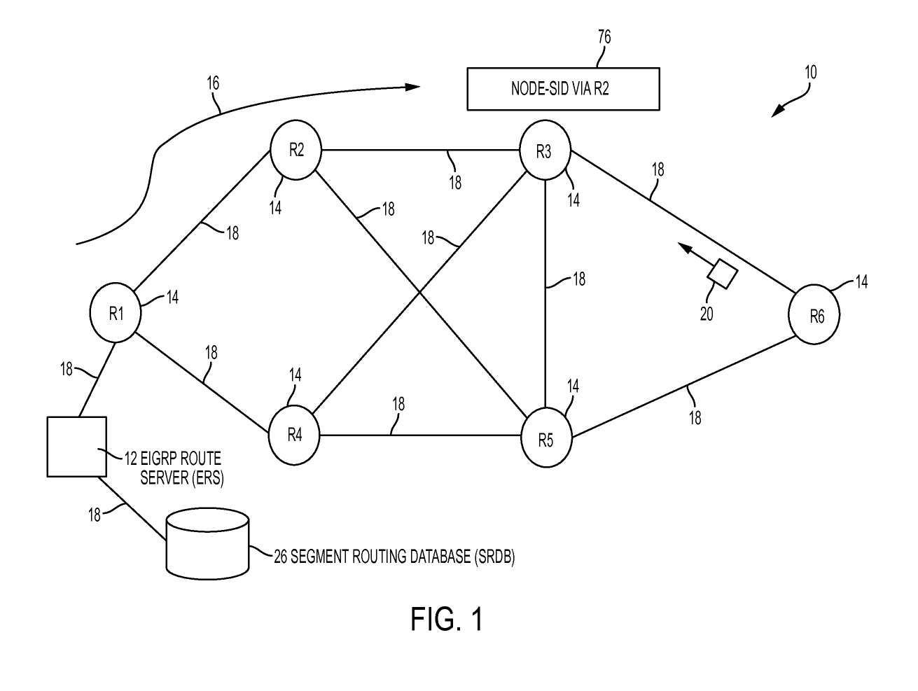

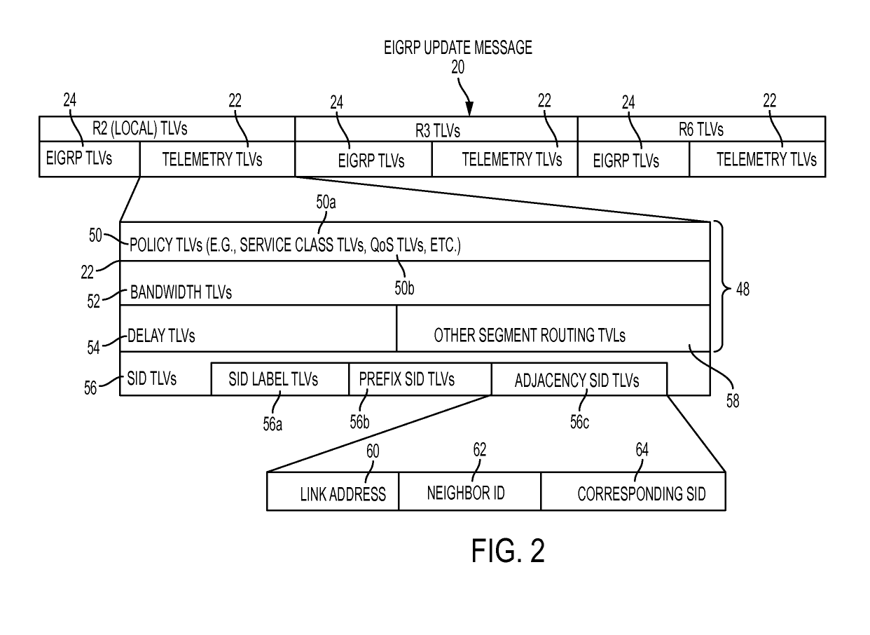

FIG. 1 is a diagram illustrating an example network 10 having an EIGRP route server (ERS) device 12 and EIGRP routers “R1, “R2”, “R3”, “R4”, and “R5” 14 for routing network traffic along service-optimized paths 16, according to an example embodiment. The EIGRP routers 14 and the EIGRP route server device 12 are interconnected by wired and/or wireless data links 18. Each EIGRP router 14 is configured for generating an EIGRP update message 20: as described in further detail below with respect to FIG. 2, each EIGRP update message 20 generated by an EIGRP router 14 can include telemetry information (22 of FIG. 2) that includes service-based attributes associated with the corresponding EIGRP router 14, in addition to EIGRP information (24 of FIG. 2) generated by the corresponding EIGRP router 14 according to EIGRP protocol. In other words, the telemetry information 22 in the EIGRP update message 20 can include all service-based attributes associated with forwarding network traffic according to a prescribed service level for an identified service type. The telemetry information 22 also can include topology information detected by the EIGRP router 14 having generated the EIGRP update message 20.

The EIGRP route server device 12 can receive the EIGRP update message 20 from one or more of the EIGRP routers “R1, “R2”, “R3”, “R4”, and/or “R5” 14. Although FIG. 1 illustrates the EIGRP route server device 12 as connected to the EIGRP router “R1”, the EIGRP route server device 12 can be connected to another network device in the data network 10, for example two or more EIGRP routers 14, a network switch, etc. In one example embodiment, the EIGRP route server device 12 can be positioned near a summary point (e.g., EIGRP router “R1” 14) in the EIGRP network 12.

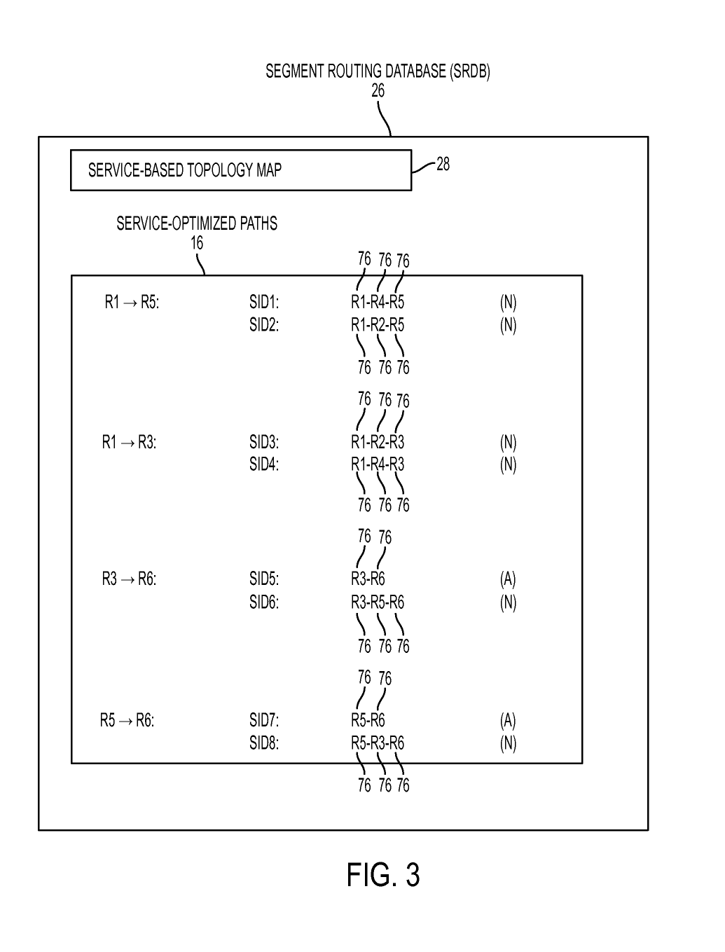

The EIGRP route server device 12, in response to receiving an EIGRP update message 20, can store the EIGRP information 24 and telemetry information 22 in a segment routing database (SRDB) 26. As described in further detail with respect to FIG. 3, the EIGRP route server device 12 can generate and store, in the telemetry information 22, a service-based topology map (28 of FIG. 3) that identifies the data network 10 based not only on its physical topology, but also based on its logical topology overlying the physical topology and that is defined by the service-based attributes that provide prescribed service levels for identified service types. In other words, the service-based topology map 28 can provide a mapping between the physical topology and the service levels for identified service types.

Hence, the EIGRP route server device 12 (and/or a Path Computation Element (PCE)) can generate one or more service-optimized paths (16 of FIG. 3) for reaching a destination network device based on the telemetry information 22, namely based on the service-based topology map 28 generated based on the telemetry information 22 in the received EIGRP update messages 20. In one example embodiment, the EIGRP route server device 12 can generate and store in the segment routing database 26 a plurality of identified segments (76 of FIGS. 1 and 3) for segment routing, where each identified segment is for executing a routing instruction according to a corresponding identified service type. Hence, the EIGRP route server device 12 can create each service-optimized path 16 using one or more of the segments 76 associated with an identified type that corresponds to the requirements of the service-optimized path. Additional details regarding segment routing can be found, for example, from the Internet Engineering Task Force (IETF) Source Packet Routing in Networking (“SPRING”) Working Group.

Hence, the example embodiments enable EIGRP update messages 20 to transmit telemetry information 22 that enable generation of service-optimized paths for reaching a destination, for example generation of Segment Routing based paths that are optimized for reaching a destination network device according to an identified service type.

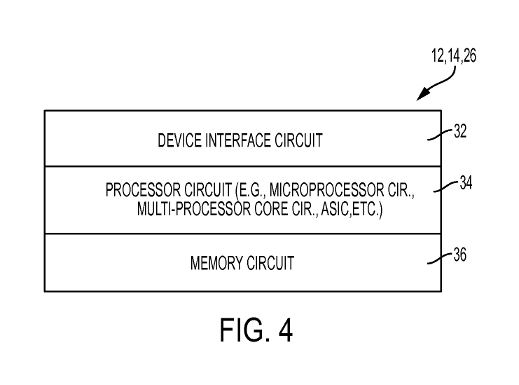

FIG. 4 illustrates an example implementation of any one of the EIGRP route server device 12, the 14, and/or the segment routing database 26, or any network device in the data network 10, according to an example embodiment. Each apparatus 12, 14, and/or 26 is a physical machine (i.e., a hardware device) configured for implementing network communications with other physical machines via the data network 10. The term “configured for” or “configured to” as used herein with respect to a specified operation refers to a device and/or machine that is physically constructed and arranged to perform the specified operation. Hence, the apparatus 12, 14, and/or 26 is a network-enabled machine implementing network communications via the data network 10.

Each apparatus 12, 24, and/or 26 can include a device interface circuit 32, a processor circuit 34, and a memory circuit 36. The device interface circuit 32 can include one or more distinct physical layer transceivers for communication with any one of the other devices 12, 24, and/or 26; the device interface circuit 32 also can include an IEEE based Ethernet transceiver for communications with the devices of FIG. 1 via any of the links 18 (e.g., a wired or wireless link, an optical link, etc.). The processor circuit 34 can be configured for executing any of the operations described herein, and the memory circuit 36 can be configured for storing any data or data packets as described herein.

Any of the disclosed circuits of the devices 12, 24, and/or 26 (including the device interface circuit 32, the processor circuit 34, the memory circuit 36, and their associated components) can be implemented in multiple forms. Example implementations of the disclosed circuits include hardware logic that is implemented in a logic array such as a programmable logic array (PLA), a field programmable gate array (FPGA), or by mask programming of integrated circuits such as an application-specific integrated circuit (ASIC). Any of these circuits also can be implemented using a software-based executable resource that is executed by a corresponding internal processor circuit such as a microprocessor circuit (not shown) and implemented using one or more integrated circuits, where execution of executable code stored in an internal memory circuit (e.g., within the memory circuit 36) causes the integrated circuit(s) implementing the processor circuit to store application state variables in processor memory, creating an executable application resource (e.g., an application instance) that performs the operations of the circuit as described herein. Hence, use of the term “circuit” in this specification refers to both a hardware-based circuit implemented using one or more integrated circuits and that includes logic for performing the described operations, or a software-based circuit that includes a processor circuit (implemented using one or more integrated circuits), the processor circuit including a reserved portion of processor memory for storage of application state data and application variables that are modified by execution of the executable code by a processor circuit. The memory circuit 36 can be implemented, for example, using a non-volatile memory such as a programmable read only memory (PROM) or an EPROM, and/or a volatile memory such as a DRAM, etc.

Further, any reference to “outputting a message” or “outputting a packet” (or the like) can be implemented based on creating the message/packet in the form of a data structure and storing that data structure in a non-transitory tangible memory medium in the disclosed apparatus (e.g., in a transmit buffer). Any reference to “outputting a message” or “outputting a packet” (or the like) also can include electrically transmitting (e.g., via wired electric current or wireless electric field, as appropriate) the message/packet stored in the non-transitory tangible memory medium to another network node via a communications medium (e.g., a wired or wireless link, as appropriate) (optical transmission also can be used, as appropriate). Similarly, any reference to “receiving a message” or “receiving a packet” (or the like) can be implemented based on the disclosed apparatus detecting the electrical (or optical) transmission of the message/packet on the communications medium, and storing the detected transmission as a data structure in a non-transitory tangible memory medium in the disclosed apparatus (e.g., in a receive buffer). Also note that the memory circuit 36 can be implemented dynamically by the processor circuit 34, for example based on memory address assignment and partitioning executed by the processor circuit 34.

Also note that although the segment routing database 26 is illustrated as distinct from the EIGRP route server device 12, the segment routing database 26 also can be implemented within the EIGRP route server device 12 (or a PCE), for example based on storage of the segment routing database 26 within the memory circuit 36 (or attached disk or solid-state memory drive) of the EIGRP route server device 12 (or the PCE).

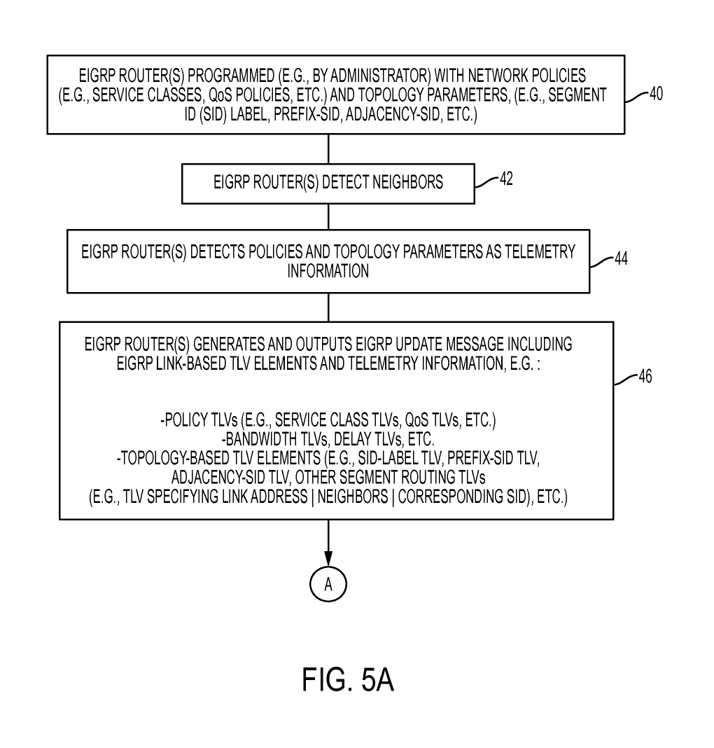

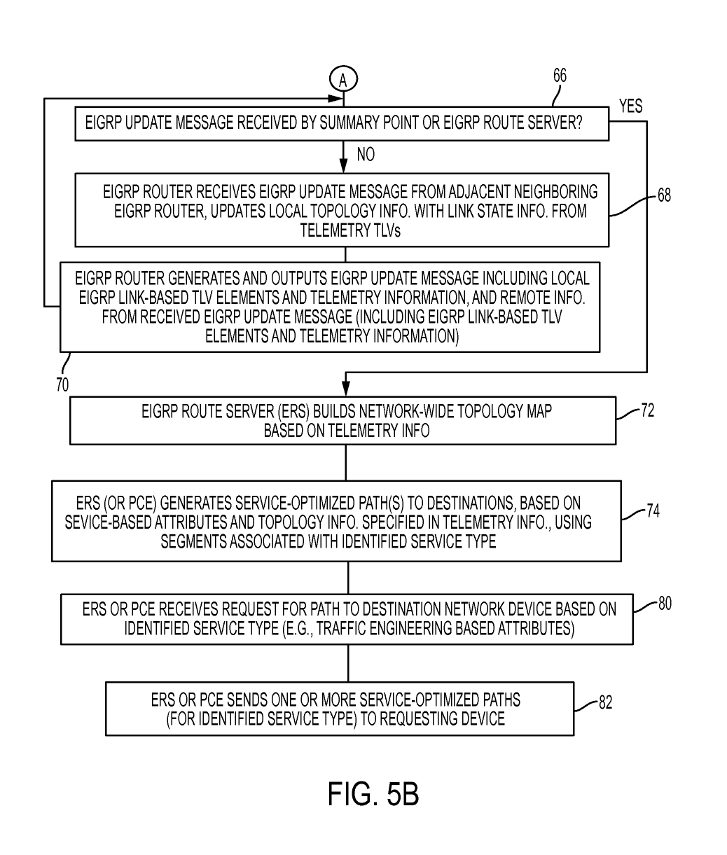

FIGS. 5A and 5B illustrate an example method of the devices of FIG. 1 in the outputting of an EIGRP update message containing telemetry information, and generating one or more service-optimized paths based on the telemetry information, according to an example embodiment.

The operations described with respect to any of the Figures can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.). Hence, one or more non-transitory tangible media can be encoded with logic for execution by a machine, and when executed by the machine operable for the operations described herein.

In addition, the operations described with respect to any of the Figures can be performed in any suitable order, or at least some of the operations in parallel. Execution of the operations as described herein is by way of illustration only; as such, the operations do not necessarily need to be executed by the machine-based hardware components as described herein; to the contrary, other machine-based hardware components can be used to execute the disclosed operations in any appropriate order, or at least some of the operations in parallel.

Referring to FIG. 5A, each EIGRP router 14 in operation 40 can be configured (e.g., programmed) by an administrator with network policies; for example, the processor circuit 34 can be configured (e.g., based on storage of associated parameters in the corresponding memory circuit 36) for executing prescribed routing operations according to prescribed network policies for different service classes, where the EIGRP router 14 can enforce various traffic engineering (TE) policies (e.g., QoS policies, minimum/maximum bandwidth, maximum delay, preferred next-hop path, etc.) for an identified service class. Each EIGRP router 14 also can be configured with prescribed Segment Routing identifiers that identify the corresponding segment 76 that provides a corresponding routing instruction, for example a segment identifier (SID) label allocated to the EIGRP router 14, a prefix segment identifier (identifying a reachable network prefix), an adjacency SID identifying an adjacent (i.e., next-hop neighbor) EIGRP router 14 by its SID, etc.

The processor circuit 34 of each EIGRP router 14 in operation 42 also can detect its neighbors, for example according to EIGRP protocol, and/or another protocol (for example based on exchange of advertisement messages advertising segment identifiers (SIDs). For example, segment identifiers (SIDs) can be assigned to different “executable routing instructions” in the data network 10, where a SID can be executable by one or more of the EIGRP routers 14 for one or more identified service types. Hence, segment routing can be implemented in the data network 10 based on the processor circuit 34 in the EIGRP route server device 12 (or a PCE) generating a service-optimized path 16 for reaching a destination network device (e.g., the EIGRP router “R6” 14), the service-optimized path 16 comprising a sequence of executable segments 76 (identified by respective SIDs) that are executed by one or more of the EIGRP routers 14, where a SID may identify an adjacency SID (for reaching an adjacent EIGRP router 14), a prefix SID (associating the SID with a prescribed Internet Protocol (IP) address prefix), a SID label associated with a particular routing instruction (e.g., providing a guaranteed Quality of Service (QoS), providing a prescribed minimum or maximum bandwidth, ensuring transmission to a destination is below a prescribed maximum delay, etc.).

The processor circuit 34 of each EIGRP router 14 in operation 44 can detect each of the policies and topology parameters obtained in operations 40 and 42 as telemetry information, and generate in operation 46 an EIGRP update message 20 that includes EIGRP information 24 and telemetry information 22, illustrated in FIG. 2.

FIG. 2 illustrates in further detail the EIGRP update message 20 generated by the processor circuit 34 of an EIGRP router 14 in operation 46. The telemetry information 22 and the EIGRP information 24 can be implemented as one or more Type-Length-Value (TLV) elements specifying one or more prescribed TLV parameters as defined by an administrator of the data network 10. For example, the EIGRP information 24 can include EIGRP-based TLVs that can be defined by an administrator according to deployment of EIGRP in the data network 10; example EIGRP-based TLVs in the EIGRP information 24 can include adjacency information discovered during exchange of EIGRP messages between adjacent EIGRP routers 14 during EIGRP neighbor discovery and maintenance. The processor circuit 34 in the EIGRP router 14 also can dynamically generate TLVs, for example according to a prescribed schema that enables the EIGRP route server 12 to parse and interpret the dynamically-generated TLVs.

The telemetry information 22 generated by the processor circuit 34 of an EIGRP router 14 in operation 46 can include service-based attributes 48 and topology information 56, also referred to generally as non-EIGRP TLV elements. The service-based attributes 48 can be illustrated in FIGS. 2 and 5A as policy TLVs 50, bandwidth TLVs 52, delay TLVs, and other segment routing TLVs 58 (i.e., distinct from the topology-specific TLVs, described below with respect to the segment ID TLVs 56). The policy TLVs 50 can include service class TLVs 50a specifying prescribed service classes that can be processed by the corresponding EIGRP router 14 (e.g., lowest priority class, low priority class, moderate priority class, high-priority class, and/or management (highest) priority class), and QoS TLVs 50b specifying prescribed Quality of Service (QoS) levels enforceable by the corresponding EIGRP router 14. The bandwidth TLVs 52 can include identifiable bandwidth parameters, for example maximum bandwidth for identified data links, bandwidth (e.g., traffic) statistics on identified data links such as percentage of utilization at different times, etc. The delay TLVs 54 can include maximum delay policies enforced by the EIGRP router 14 for one or more identified service types, etc. The other segment routing TLVs 58 can identify other segment routing “instructions” defined by the administrator of the data network 10 and executed by the EIGRP router 14 for an identified service type.

Hence, the service-based attributes 48 can identify all service-based parameters and/or attributes associated with the EIGRP router 14 enforcing one or more service types or service levels.

The telemetry information 22 also can include segment ID TLVs 56 that can describe topology information for the corresponding EIGRP router 14, including link-state information, Segment Routing-based topology parameters associated with mapping the logical Segment Routing topology to the physical topology identifiable by the EIGRP information 24. Example SID TLVs 56 can include a SID Label TLVs (identifying a specific SID Label) 56a associated with one or more prefix SID TLVs 56b and/or one or more adjacency SID TLVs 56c. As illustrated in FIG. 2, an adjacency SID TLV 56c can include an association between a link address 60 (e.g., “interface identifier”) for a link interface of the device interface circuit 32 of the EIGRP router 14, a corresponding neighbor identifier 62, and a neighbor SID 64 specifying the corresponding SID of the neighbor reachable via the corresponding link address 60. Other SID TLVs 56 can identify MPLS-based segment labels, IPv6 addresses used for Segment Routing identification, etc.

Although not shown in FIG. 2, the EIGRP update message 20 also can include sequence numbers and/or version numbers for any one of the telemetry TLVs 22, the EIGRP TLVs 24, or any components thereof.

Hence, the EIGRP update message 20 output by the device interface circuit 32 of the EIGRP router 14 in operation 46 of FIG. 5A can specify telemetry information 22 that can identify all detected attributes that enable the EIGRP router 14 to execute routing along a data link 18 according to one or more identified service types. The term “telemetry” refers to measurement or detection by the processor circuit 34 of data, attributes, configuration parameters, etc. associated with the EIGRP router 14 (e.g., in operations 40, 42, and 44), where the measured/collected data (or parameters) are added to the telemetry information 22 as TLVs for parsing and interpretation by the EIGRP route server device 12. In other words, the telemetry refers to the monitoring and/or measuring of the attributes of the data network 10 as detected by the EIGRP router 14 and/or the attributes of the EIGRP router 14 that describe the operations of the EIGRP router 14 (for identified service types) in the data network 10.

The device interface circuit 32 of an EIGRP router (e.g., “R6”) 14 is configured for outputting in operation 46 the generated EIGRP update message 20 to its adjacent (i.e. next-hop) EIGRP router (e.g., “R3” and/or “R5”) 14 via a data link 18, for forwarding and delivery to the EIGRP route server device 12 (deployed, for example, near a summary point such as the EIGRP router “R1” 14). The telemetry information 22 also can be specified in an EIGRP Query message and/or an EIGRP Reply message, as appropriate. As described in further detail below with respect to FIG. 5B, the collection of EIGRP update messages 20 from the EIGRP routers 14 in the data network 10 enable the EIGRP route server device 12 to build the service-based topology map 28 for generation of one or more service-optimized paths 16 for reaching a destination network device.

Assume with respect to FIG. 5B that the EIGRP router “R6” 14 has output an EIGRP router 14 that specifies only the local EIGRP information 24 and local telemetry information 22 originated by the EIGRP router “R6” 14 (i.e., does not have any EIGRP information 24 or telemetry information 22 of another neighboring EIGRP router such as “R3” or “R5”). Referring to FIG. 5B, if in operation 66 the next-hop network device receiving the EIGRP update message 20 from the EIGRP router (e.g., “R6”) is not an EIGRP summary point or an EIGRP route server device 12, but rather is another EIGRP router (e.g., “R3”) 14, the next-hop EIGRP router (e.g., “R3”) 14 receives in operation 68 the EIGRP update message 20. The processor circuit 34 of the next-hop EIGRP router (e.g., “R3”) 14 can respond to the received EIGRP update message 20 based on parsing the telemetry information 22 originated by the transmitting EIGRP router (e.g., “R6”), and updating its local topology table with link state information from the telemetry information 22.

The processor circuit 34 of the next-hop EIGRP router (e.g., “R3”) 14 can forward the EIGRP update message 20 originated by EIGRP router “R6” to its next-hop neighbor (e.g., “R4”) 14 and generate and output its own EIGRP update message 20 as described previously with respect to operations 40, 42, 44, and 46 of FIG. 5A. The processor circuit 34 of the next-hop EIGRP router (e.g., “R3”) 14 in operation 70 also can update the received EIGRP update message 20 received from the originating EIGRP router “R6” 14 with the corresponding local EIGRP information 24 and telemetry information 22, based on generating the local telemetry information 22 as described above with respect to operations 42, 44, and 46, and output the updated EIGRP update message 20 specifying the EIGRP information 24 and the telemetry information 22 for the “local” EIGRP router “R3” and the “remote” (next-hop) EIGRP router “R6”.

The telemetry information 22 can be opaque to any EIGRP router that is not configured for parsing or interpreting the telemetry information 22 in a received EIGRP update message 20; hence, a conventional EIGRP router can execute existing EIGRP update processing on the received EIGRP update message 20, while ignoring the telemetry information 22, or simply forward the received telemetry information 22.

As illustrated in FIGS. 2 and 5B, the operations 68 and 70 can be repeated for the next-hop EIGRP router “R2”, resulting in the EIGRP update message 20 of FIG. 2 that comprises the EIGRP information 24 and the telemetry information 22 generated by the local EIGRP router “R2”, the EIGRP information 24 and the telemetry information 22 (including the associated non-EIGRP TLV elements 48, 56) having been generated by the next-hop EIGRP router “R3”, and the EIGRP information 24 and the telemetry information 22 (including the associated non-EIGRP TLV elements 48, 56) of the EIGRP router “R6” having been forwarded by the next-hop EIGRP router “R3”. The operations 68 and 70 can be repeated by the next-hop EIGRP router “R1”, such that the EIGRP route server device 12 can receive in operation 66 an EIGRP update message 20 specifying the telemetry information 22 and the telemetry information 22 for the EIGRP routers “R6”, “R3”, “R2”, and “R1”. As apparent from the foregoing, the EIGRP router “R1” also can receive an EIGRP update message 20 from the EIGRP router “R2” and/or “R4” that specifies the EIGRP information 24 and the telemetry information 22 for the EIGRP routers “R4” and “R5”.

The EIGRP update message 20 sent in operation 46 can be sent directly to the EIGRP route server as a unicast, multicast, or anycast message.

In response to the device interface circuit 32 of the EIGRP route server device 12 receiving the EIGRP update message 20 from the EIGRP router “R1”, the processor circuit 34 of the EIGRP route server device 12 in operation 72 can generate a service-based topology map 28, illustrated in FIG. 3, that identifies the service-based topology attributes each of the EIGRP routers “R1”, “R2”, “R3”, “R4”, “R5”, and “R6” 14, based on the received telemetry information 22 of each of the EIGRP routers “R1”, “R2”, “R3”, “R4”, “R5”, and “R6” 14.

Hence, the processor circuit 34 of the EIGRP route server device 12 in operation 74 can generate one or more service-optimized paths 16 to an identified destination network device in the data network 10, where the destination network device can be an EIGRP router (e.g., “R6”) 14, a network device (not shown) attached to an EIGRP router device (e.g., “R6”) 14, etc. In particular, each service-optimized path 16 is based on one or more “segments” 76 having a corresponding SID that defines the routing instruction to be performed for one or more identified service types; hence, the processor circuit 34 of the EIGRP route server device 12 in operation 74 can generate a plurality of identified segments 76 for segment routing, each identified segment 76 identifying a corresponding routing instruction to be executed by an identified one or more of the EIGRP routers 14 according to a corresponding identified service type.

The processor circuit 34 of the EIGRP route server device 12 in operation 74 can generate one or more service-optimized paths 16 for an identified service type based on associating in sequence one or more of the identified segments 76 associated with the identified service type. For example, assuming multiple identified segments 76 for each of the service types “Bronze”, “Gold”, and “Platinum” (identifying for example respectively distinct QoS service types), the processor circuit 34 of the EIGRP route server device 12 can generate a service-optimized path 16 for reaching a destination network device attached to the EIGRP router “R6” 14 according to the “Gold” service type based on associating in sequence one or more identified segments 76 associated with the “Gold” service type overlying a physical path in the data network 10 from the EIGRP router “R1” 14 to the EIGRP router “R6” 14. Depending on the availability of different identified segments 76 for different service classes, different service-optimized paths may be established for different service classes to provide service differentiation between different network traffic. Further collection of telemetry information for EIGRP router devices beyond a summary point in the data network 10 can be executed by a PCE or equivalent device.

Hence, in response to the device interface circuit 32 of the EIGRP route server device 12 receiving in operation 80 a request (originated by a requesting network device) for a service-optimized path 16 for reaching a destination network device, the processor circuit 34 of the EIGRP route server device 12 in operation 82 can send one or more service-optimized paths 16 to the requesting network device (e.g., one of the EIGRP routers 14), enabling any EIGRP router 14 to reach a destination network device according to an identified service type based on the service-optimized path 16. As an alternative to operations 80 or 82, the PCE can install one or more of the service-optimized paths 16 in one or more of the EIGRP routers 14, eliminating the necessity of the EIGRP routers 14 sending a request for the path.

According to an example embodiment, telemetry information can be added to EIGRP messages, enabling generation of service-optimized paths in an EIGRP network. Hence, EIGRP networks can implement service optimization, for example based on allocating logical network resources based on service type, such as in a network implementing segment routing. The example embodiments also can be used for optimization of other service-based operations in an EIGRP network, for example implementation of traffic engineering.

Although the example embodiments have been described with respect to an EIGRP network, the example embodiments also can be applicable to data networks deploying other distance vector routing protocols.

While the example embodiments in the present disclosure have been described in connection with what is presently considered to be the best mode for carrying out the subject matter specified in the appended claims, it is to be understood that the example embodiments are only illustrative, and are not to restrict the subject matter specified in the appended claims.

What is claimed is:

1. A method comprising:
an Enhanced Interior Gateway Routing Protocol (EIGRP) route server device receiving an EIGRP update message that includes telemetry information associated with an EIGRP router, the telemetry information including service-based attributes associated with the telemetry information; and
the EIGRP route server device generating one or more service-optimized paths for reaching a destination network device based on the telemetry information, enabling any EIGRP router to reach the destination network device according to an identified service type based on the one or more service-optimized paths.

2. The method of claim 1, wherein:
the telemetry information includes topology information having been detected by an originator of the telemetry information;
the EIGRP route server device generating the one or more service-optimized paths for reaching the destination network device based on the topology information.

3. The method of claim 2, wherein the EIGRP update message specifies telemetry information for a plurality of identified EIGRP routers, enabling generating of the service-optimized paths via the identified EIGRP routers.

4. The method of claim 3, further comprising the EIGRP route server device generating a topology map of the identified EIGRP routers providing reachability to the destination network device.

5. The method of claim 1, further comprising:
the EIGRP route server device receiving a request, originated by a requesting network device, for a path for reaching the destination network device;
the EIGRP route server device sending the one or more service-optimized paths to a requesting EIGRP router, in response to the request.

6. The method of claim 1, wherein:
the generating includes generating a plurality of identified segments for segment routing, each identified segment for executing a routing instruction according to a corresponding identified service type;
the generating further including creating each service-optimized path using a plurality of said segments associated with the identified service type of the corresponding service-optimized path.

7. The method of claim 6, further comprising the EIGRP route server device storing the identified segments in a segment routing database.

8. The method of 1, wherein:
the EIGRP update message includes EIGRP-based Type-Length-Value (TLV) elements generated by a next-hop neighbor device having output the EIGRP update message;
the telemetry information in the EIRGP update message including first non-EIGRP TLV elements generated by the next-hop neighbor device, and second non-EIGRP TLV elements having been forwarded by the next-hop neighbor device from another EIGRP router.

9. An apparatus comprising:
a device interface circuit configured for receiving an EIGRP update message that includes telemetry information associated with an EIGRP router, the telemetry information including service-based attributes associated with the telemetry information; and
a processor circuit configured for generating one or more service-optimized paths for reaching a destination network device based on the telemetry information, enabling any EIGRP router to reach the destination network device according to an identified service type based on the one or more service-optimized paths.

10. The apparatus of claim 9, wherein:
the telemetry information includes topology information having been detected by an originator of the telemetry information;
the processor circuit configured for generating the one or more service-optimized paths for reaching the destination network device based on the topology information associated with the telemetry information.

11. The apparatus of claim 10, wherein the EIGRP update message specifies telemetry information for a plurality of identified EIGRP routers, the processor circuit configured for generating the service-optimized paths for reaching the destination network device via the identified EIGRP routers.

12. The apparatus of claim 11, wherein the processor circuit further is configured for generating a topology map of the identified EIGRP routers providing reachability to the destination network device.

13. The apparatus of claim 9, further wherein:
the device interface circuit further is configured for receiving a request, originated by a requesting network device, for a path for reaching the destination network device;
the processor circuit further configured for sending the one or more service-optimized paths to a requesting EIGRP router, in response to the request.

14. The apparatus of claim 9, wherein:
the processor circuit is configured for generating a plurality of identified segments for segment routing, each identified segment for executing a routing instruction according to a corresponding identified service type;
the processor circuit further is configured for creating each service-optimized path using a plurality of said segments associated with the identified service type of the corresponding service-optimized path.

15. The apparatus of claim 14, wherein the processor circuit is configured for storing the identified segments in a segment routing database.

16. The apparatus of 9, wherein:
the EIGRP update message includes EIGRP-based Type-Length-Value (TLV) elements generated by a next-hop neighbor device having output the EIGRP update message;
the telemetry information in the EIGRP update message including first non-EIGRP TLV elements generated by the next-hop neighbor device, and second non-EIGRP TLV elements having been forwarded by the next-hop neighbor device from another EIGRP router.

17. One or more non-transitory tangible media encoded with logic for execution by a machine and when executed by the machine operable for:
receiving an EIGRP update message that includes telemetry information associated with an EIGRP router, the telemetry information including service-based attributes associated with the telemetry information; and
generating one or more service-optimized paths for reaching a destination network device based on the telemetry information, enabling any EIGRP router to reach the destination network device according to an identified service type based on the one or more service-optimized paths.

18. The one or more non-transitory tangible media of claim 17, wherein:
the telemetry information includes topology information having been detected by an originator of the telemetry information;
the generating including generating the one or more service-optimized paths for reaching the destination network device based on the topology information associated with the telemetry information.

19. The one or more non-transitory tangible media of claim 17, further operable for:
receiving a request, originated by a requesting network device, for a path for reaching the destination network device; and
sending the one or more service-optimized paths to a requesting EIGRP router, in response to the request.

20. The one or more non-transitory tangible media of claim 17, wherein:
the generating includes generating a plurality of identified segments for segment routing, each identified segment for executing a routing instruction according to a corresponding identified service type;
the generating further including creating each service-optimized path using a plurality of said segments associated with the identified service type of the corresponding service-optimized path.

21. An apparatus comprising:
a processor circuit configured for generating an Enhanced Interior Gateway Routing Protocol (EIGRP) update message that includes telemetry information generated by the processor circuit based on detected attributes associated with the apparatus; and
a device interface circuit configured for outputting the EIGRP update message to an adjacent router device, for generation of a service-optimized path for reaching a destination network device.

22. The apparatus of claim 21, wherein:
the processor circuit is configured for detecting topology information associated with the apparatus;
the processor circuit configured for adding, within the telemetry information, the topology information.
